(19) United States
(12) Patent Application Publication
(10) Pub. No.: US 2017/0300280 A1
(43) Pub. Date: Oct. 19, 2017

(54) IMAGE PROCESSING APPARATUS AND IMAGE PROCESSING METHOD

(71) Applicant: Tomoyuki TSUKUDA, Kanagawa (JP)

(72) Inventor: Tomoyuki TSUKUDA, Kanagawa (JP)

(21) Appl. No.: 15/642,797

(22) Filed: Jul. 6, 2017

Related U.S. Application Data
(63) Continuation of application No. PCT/JP2016/000148, filed on Jan. 13, 2016.

(30) Foreign Application Priority Data
Jan. 15, 2015 (JP) 2015-005760

(51) Int. Cl. G06F 3/147; G06T 11/60; G09G 5/12; G06F 3/0488; G06F 3/042

(52) U.S. Cl. CPC G06F 3/147; G09G 5/12; G06F 3/04883; G06T 11/60; G06F 3/0421; G09G 2370/12; G09G 2370/16

(57) ABSTRACT

An image processing apparatus includes: an image drawing unit that draws an image transmitted from an external device; a display unit that displays thereon the image; a handwriting image drawing unit that draws a handwriting image on the display unit; a handwriting detector that detects handwriting image on the display unit; and an alert controller that generates an alert dialogue configured to be displayed on the display unit, wherein the alert controller includes, a first determining unit that determines whether the image is displayed on the display unit, and a second determining unit that determines whether the handwriting image is drawn on the display unit, the alert controller generates, when the image is displayed and the handwriting image is drawn, an alert dialogue containing a message that prompts a user to save a combined image of the displayed image and the handwriting image drawn on the display unit.

### CROSS-REFERENCE TO RELATED APPLICATIONS

This application is a continuation of PCT international application Ser. No. PCT/JP2016/000148 filed on Jan. 13, 2016 which designates the United States, incorporated herein by reference, and which claims the benefit of priority from Japanese Patent Applications No. 2015-005760, filed on Jan. 15, 2015, incorporated herein by reference.

### BACKGROUND OF THE INVENTION

### 1. Field of the Invention

The present invention relates to an image processing apparatus and an image processing method.

### 2. Description of the Related Art

Interactive whiteboard systems are known that include a touchscreen mounted on a flat panel display such as a liquid crystal display or a plasma display, or on a display using a projector.

Japanese Laid-open Patent Publication No. 2014-000777 discloses an interactive whiteboard system including a display unit that displays image data transmitted from an external device such as a computer. This interactive whiteboard system includes an input unit that receives an input of an image drawn by a user, and a controller that combines the image drawn by the user with the image data and displays the combined image on the display unit. The interactive whiteboard system also includes a recording unit that records the combined image displayed on the display unit. The controller controls the recording unit to record the combined image at regular intervals, so that the user can retrieve later what the user has historically drawn on the image data.

Such an interactive whiteboard system, however, may fail to record the combined image if the user inputs an image into the input unit at shorter intervals than the intervals at which the recording unit records the combined image.

### SUMMARY OF THE INVENTION

It is an object of the present invention to at least partially solve the problems in the conventional technology.

According to an exemplary embodiment of the present invention, there is provided an image processing apparatus comprising: an image drawing unit configured to draw an image transmitted from an external device; a display unit configured to display thereon the image; a handwriting image drawing unit configured to draw a handwriting image on the display unit; a handwriting detector configured to detect handwriting image on the display unit; and an alert controller configured to generate an alert dialogue configured to be displayed on the display unit, wherein the alert controller includes, a first determining unit configured to determine whether the image is displayed on the display unit, and a second determining unit configured to determine whether the handwriting image is drawn on the display unit, the alert controller generates, when the image is displayed and the handwriting image is drawn, an alert dialogue containing a message that prompts a user to save a combined image of the image displayed on the display unit and the handwriting image drawn on the display unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an image processing system according to an embodiment of the present invention;

FIG. 2 is a diagram illustrating a hardware configuration and a functional configuration of an image processing apparatus according to the embodiment of the present invention;

FIG. 3 is a flowchart illustrating an example of processing performed by an alert controller; and

FIG. 4 is a flowchart illustrating another example of the processing performed by the alert controller.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

The image processing apparatus according to the present invention displays an alert dialogue that prompts a user to save a combined image of a display image of a user's personal computer (PC) and a handwriting image when the user writes something over the display image for the first time after an external device such as the user's PC is connected to the image processing apparatus and the display image of the user's PC is displayed on the display unit. This processing enables the user to save the combined image at appropriate timing. In other words, the user can save the combined image after the user draws the handwriting image and before the display image of the user's PC is changed.

Features of the present invention above will be described in detail below with reference to the accompanying drawings. The constituent elements, kinds, combinations, forms, and their relative configurations described in the embodiments are not intended to limit the scope of the present invention and thus are mere examples for describing the present invention unless otherwise specifically stated.

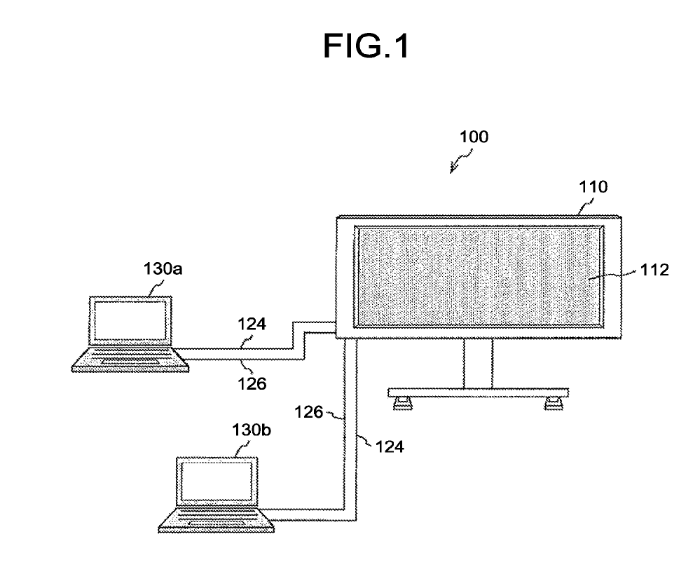

FIG. 1 is a diagram illustrating an image processing system according to an embodiment of the present invention.

An image processing system 100 is configured by an image processing apparatus 110 and user's PCs 130a and 130b. The user's PCs 130a and 130b are each connected to the image processing apparatus 110 via cables 124 and 126.

The image processing apparatus 110 can display images displayed on the user's PCs 130a and 130b, and can display drawing images generated by stroke operations of the user. The image processing apparatus 110 generates an event by a touch operation on a display unit 112, and transmits the event to the user's PCs 130a and 130b as an event of an input device such as a mouse or a keyboard.

The user's PCs 130a and 130b are information processing devices that provide the image processing apparatus 110 with images to display. The user's PCs 130a and 130b each include an interface that outputs image signals. The image signals form the display image of the user's PCs 130a and 130b, and are provided to the image processing apparatus 110 at a certain rate (for example, 30 frames per second).

In the present embodiment, the user's PCs 130a and 130b each include video graphics array (VGA) output terminals as the output interface. The user's PCs 130a and 130b can transmit VGA signals to the image processing apparatus 110 via the cables 124 such as VGA cables. In some embodiments, the user's PCs 130a and 130b may transmit their display image via wireless communication conforming to certain wireless communication protocols.

The user's PCs 130a and 130b can acquire an image displayed on the display unit 112 of the image processing apparatus 110. The user's PCs 130a and 130b each include a universal serial bus (USB) port, and are connected to the image processing apparatus 110 via the respective USB cables 126. The user's PCs 130a and 130b can acquire the display image stored in the image processing apparatus 110 by using a general-purpose driver such as a USB mass storage class driver.

The user's PCs 130a and 130b in the embodiment illustrated in FIG. 1 are notebook computers. In some embodiments, the user's PCs 130a and 130b may be any information processing devices, such as desktop computers, tablet computers, personal digital assistants (PDAs), digital video cameras, and digital cameras, each of which can provide image frames. Although the image processing system 100 illustrated in FIG. 1 includes two user's PCs 130a and 130b, it may include one user's PC or three or more user's PCs in some embodiments.

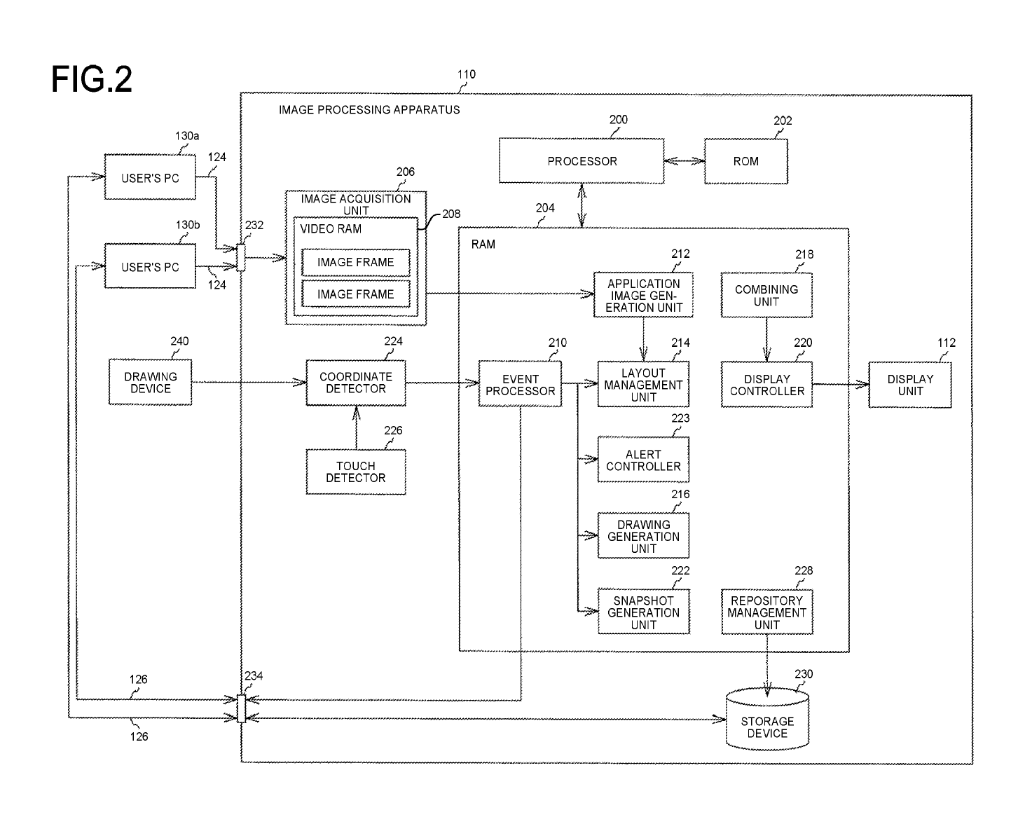

FIG. 2 is a diagram illustrating a hardware configuration and a functional configuration of the image processing apparatus according to the embodiment of the present invention.

The image processing apparatus 110 includes an image input interface 232 and an image output interface 234, and connects to the user's PCs 130a and 130b via these interfaces.

The image input interface 232 receives image signals that form display images of the user's PCs 130a and 130b. In the present embodiment, the image input interface 232 may be a digital visual interface (DVI) connector configured by DVI terminals. The image input interface 232 receives VGA signals from the user's PCs 130a and 130b via the cables 124 such as VGA cables, and provides the VGA signals to an image acquisition unit 206 included in the image processing apparatus 110. In some embodiments, the image input interface 232 may be, for example, a VGA connector, a high-definition multimedia interface (HDMI) (registered trademark) connector, or a DisplayPort connector. In other embodiments, the image input interface 232 may receive image signals from the user's PCs 130a and 130b via wireless communication conforming to a wireless communication protocol such as Bluetooth (registered trademark) or Wi-Fi.

The image output interface 234 is a physical interface that outputs a display image of the image processing apparatus 110 to external devices such as the use's PCs 130a and 130b. In the present embodiment, the image output interface 234 may be a USB socket.

The image processing apparatus 110 is configured by a processor 200, a read only memory (ROM) 202, a random access memory (RAM) 204, the image acquisition unit 206, a coordinate detector 224, a touch detector 226, and the display unit 112.

The processor 200 is a processing unit such as a central processing unit (CPU) or a micro processing unit (MPU). The processor 200 runs an operating system (OS) such as Windows (registered trademark) series, UNIX (registered trademark), LINUX (registered trademark), TRON, ITRON, pITRON, Chrome, or Android, and executes a computer program according to the present invention described in a programming language such as an assembly language, C, C++, Java (registered trademark), JavaScript (registered trademark), Perl, Ruby, or Python under the OS's environment.

The ROM 202 is a non-volatile memory that stores computer programs including a boot program such as the basic input/output system (BIOS).

The RAM 204 is a main memory such as a dynamic RAM (DRAM) or a static RAM (SRAM). The RAM 204 provides execution space for executing the computer program according to the present invention. The processor 200 reads the computer program according to the present invention from a hard disk drive (not illustrated) that persistently stores software programs and various kinds of data, and loads the computer program on the RAM 204 to execute it. The computer program according to the present invention includes program modules that are an event processor 210, an application image generation unit 212, a layout management unit 214, a drawing generation unit 216, a combining unit 218, a display controller 220, a snapshot generation unit 222, a repository management unit 228, and an alert controller 223.

The image acquisition unit 206 is a functional unit that acquires image signals from the user's PCs 130a and 130b. When the image acquisition unit 206 receives the image signals from the user's PCs 130a and 130b via the image input interface 232, the image acquisition unit 206 analyzes the image signals and extracts image information such as the resolution of image frames that are the display images of the user's PCs 130a and 130b formed by the image signals, and update frequency of the image frames. The image acquisition unit 206 then transmits the image information to the application image generation unit 212. The image acquisition unit 206 uses the image signals to create image frames that are the display images of the user's PCs 130a and 130b, and overwrites the image frames in a video RAM 208 that is a storage unit that can transitorily store image data.

The application image generation unit 212 is a functional unit that generates various kinds of display windows configured to be displayed on the display unit 112. Examples of the display windows include a display window for displaying the image frames that are the display images of the user's PCs 130a and 130b, a display window for displaying a drawing image generated by a user, a display window for displaying buttons and menus for various settings on the image processing apparatus 110, and a display window for file viewers and web browsers. The application image generation unit 212 draws these display windows on image layers allocated for the respective display windows.

The layout management unit 214 is a functional unit that draws the display image of the user's PCs 130a and 130b on a display window generated by the application image generation unit 212. When the layout management unit 214 acquires image information from the image acquisition unit 206, it acquires the image frames stored in the video RAM 208. The layout management unit 214 then changes the size of the image frames by using the image information to fit it to the size of the display window generated by the application image generation unit 212, and draws the image frames on an image layer allocated for the image frames.

The touch detector 226 is a functional unit that detects a touch of an object such as a drawing device 240. In the present embodiment, the image processing apparatus 110 includes, as the touch detector 226, a coordinates input and detection device that uses what is called an infrared beam disruption method. Such a coordinates input and detection device includes two light emitting and receiving devices disposed at both sides of a lower part of the display unit 112 illustrated in FIG. 1. These light emitting and receiving devices emit a plurality of infrared beams that travel parallel to the screen of the display unit 112. The infrared beams are reflected on reflective members provided around the display unit 112, travel back on the same optical paths, and are received by the light emitting and receiving devices. The touch detector 226 notifies the coordinate detector 224 of identification information of infrared beams emitted from the two light emitting and receiving devices and disrupted by the object, and the coordinate detector 224 determines the coordinate position, which is the touch position of the object.

In some embodiments, the image processing apparatus 110 may include other kinds of detectors, such as a capacitive touchscreen panel that determines the touch position by detecting a change in capacitance, a resistive touchscreen panel that determines the touch position by a change in voltage in two resistive layers facing each other, and an electromagnetic touchscreen panel that determines the touch position by detecting electromagnetic induction that occurs when a touching object touches the display unit.

The coordinate detector 224 is a functional unit that calculates a coordinate position that is a touch position of the object on the display unit 112, and issues various kinds of events. In the present embodiment, the coordinate detector 224 calculates the coordinate position of the object's touch position by using the identification information of the disrupted infrared beams received from the touch detector 226. The coordinate detector 224 issues various kinds of events to the event processor 210 together with the coordinate position of the touch position.

The events issued by the coordinate detector 224 include an event (TOUCH) for notifying the event processor 210 of the object's touching or approaching the display unit 112, an event (MOVE) for notifying the event processor 210 of a move of a touch point or an approach point of the object with the object touching or staying close to the display unit 112, and an event (RELEASE) for notifying the event processor 210 of the leaving of the object from the display unit 112. These events contain coordinate position information on touch position coordinates and approach position coordinates.

The drawing device 240 is a device for drawing an image by touching the touch detector 226 of the image processing apparatus 110. The drawing device 240 is a pen-shaped device with a touch detector at its leading end that detects a touch of an object. When the touch detector touches an object, it transmits a touch signal indicating that the touch detector is touching an object to the coordinate detector 224 together with the identification information of the drawing device.

The drawing device 240 has a mode changing switch that switches modes between an image processing apparatus operating mode and a user's PC operating mode. The mode changing switch is disposed, for example, on a side surface or on the trailing end of the drawing device 240. In the image processing apparatus operating mode, the user can draw or write any shapes or characters on the display unit 112 of the image processing apparatus 110, and can also select objects such as menus and buttons displayed on the display unit 112. In the user's PC operating mode, the user can select objects such as menus and buttons displayed on the display unit 112.

For example, when the user touches the image processing apparatus 110 with the drawing device 240 with the mode changing switch kept being pressed, the drawing device 240 transmits a touch signal, the identification information of the drawing device, and a mode type signal indicating the user's PC operating mode. When the user touches the image processing apparatus 110 with the drawing device 240 without pressing the mode changing switch, the drawing device 240 transmits a touch signal, the identification information of the drawing device, and a mode type signal indicating the image processing apparatus operating mode.

In the present embodiment, when the coordinate detector 224 receives the identification information of the infrared beams from the touch detector 226, the coordinate detector 224 calculates the coordinate position that is the touch position of the object. Subsequently, the coordinate detector 224 receives a touch signal from the drawing device 240, and issues certain events. At this time, the coordinate detector 224 also notifies the event processor 210 of information on the mode type (hereinafter referred to as “mode type information”) together with the events.

In the present embodiment, the drawing device 240 transmits various kinds of signals via short distance wireless communication such as Bluetooth (registered trademark). In some embodiments, the drawing device 240 may transmit various kinds of signals via wireless communication using ultrasonic waves or infrared beams.

The event processor 210 is a functional unit that processes the events issued by the coordinate detector 224. When the event processor 210 receives an event from the coordinate detector 224 with the user's PC operating mode being selected, the event processor 210 transmits a mouse event to the user's PC 130a or 130b. When the event processor 210 receives an event from the coordinate detector 224 with the image processing apparatus operating mode being selected, the event processor 210 notifies other functional units of the image processing apparatus 110 of a drawing instruction event and a selection notification event.

The mouse event works in the same manner as an event issued by the input device such as a mouse of the user's PCs 130a and 130b. When the user's PC operating mode is selected, the mouse event is issued to the user's PCs 130a and 130b upon a touch operation of the drawing device 240. The event processor 210 converts the coordinate position information contained in the event issued by the coordinate detector 224 into coordinate position information that corresponds to the screen size of the user's PCs 130a and 130b, and transmits the converted coordinate position information to the user's PCs 130a and 130b together with the mouse event. The user's PCs 130a and 130b process the mouse event in the same manner as in a case in which they process an event issued by the input device such as a mouse.

The drawing instruction event is an event for instructing the image processing apparatus 110 to draw. When the image processing apparatus operating mode is selected, the drawing instruction event is issued upon a touch operation of the drawing device 240 on the display unit 112.

The selection notification event is an event for indicating that the user has selected a certain object such as a button or a menu bar constituting the screen displayed on the display unit 112. When the image processing apparatus operating mode is selected, the selection notification event is issued upon a touch operation of the drawing device 240 on the display unit 112. The event processor 210 issues the selection notification event when the coordinate position information contained in the event issued by the coordinate detector 224 falls within the coordinate range of certain objects.

In the present embodiment, the drawing instruction event and the selection notification event have their own identification information. Functional units of the image processing apparatus 110 that are triggered to operate by these events refer to the identification information and execute certain processing. The selection notification event also contains identification information of the selected object. Functional units of the image processing apparatus 110 that are triggered to operate by the selection notification event refer to the identification information of the object to execute certain processing.

The drawing generation unit 216 (handwriting image drawing unit) is a functional unit that generates a drawing image drawn by a user with the drawing device 240. The drawing generation unit 216 changes the color of a coordinate position indicated by the coordinate position information to a certain color, and generates an image layer including the color-changed coordinate position. The drawing generation unit 216 stores the coordinate position, as drawing information, in a drawing information storage area in the RAM 204.

The combining unit 218 is a functional unit that combines various images. The combining unit 218 combines an image layer (hereinafter referred to as an “application image layer”) allocated for the application image generation unit 212 to draw an image with an image layer (hereinafter referred to as an “image capture layer”) allocated for the layout management unit 214 to draw the display image of the user's PCs 130a and 130b and an image layer (hereinafter referred to as a “handwriting layer”) allocated for the drawing generation unit 216 to draw an image.

The display controller 220 is a functional unit that controls the display unit 112. The display controller 220 displays the combined image generated by the combining unit 218 on the display unit 112. In the present embodiment, the combining unit 218 calls the display controller 220 to display the combined image on the display unit 112. In some embodiments, the combining unit 218 may combine the image layers at the same frequency as the update frequency of the image frames contained in the image information, and the display controller 220 may display the combined image layers on the display unit 112, accordingly.

The snapshot generation unit 222 is a functional unit that generates a snapshot image that is a combined image of the display image of the user's PCs 130a and 130b and the drawing image generated by the drawing generation unit 216. When the snapshot generation unit 222 receives a selection notification event indicating that the user has selected a snapshot button for instructing acquisition of a snapshot displayed on the display unit 112, the snapshot generation unit 222 combines the image capture layer and the handwriting layer to generate a snapshot image. After generating the snapshot image, the snapshot generation unit 222 causes the repository management unit 228 to store the snapshot image in a storage device 230.

The repository management unit 228 is a functional unit that controls the storage device 230 configured to store snapshot images. As described above, the repository management unit 228 stores the snapshot image in the storage device 230 upon receiving an instruction from the snapshot generation unit 222. The repository management unit 228 also acquires the snapshot image from the storage device 230 upon receiving an instruction from the user's PCs 130a and 130b and transmits the snapshot image to the user's PCs 130a and 130b.

The alert controller 223 is a functional unit that generates an alert dialogue configured to be displayed on the display unit 112. When the user writes something on the display unit 112 (display screen) with the drawing device 240, the alert controller 223 detects such handwriting via the event processor 210 (handwriting detector). In other words, the alert controller 223 determines that the user has written something by receiving the drawing instruction event issued by the event processor 210 upon a touch operation of the drawing device 240. The alert controller 223 displays the alert dialogue on the display unit 112 when the detected handwriting is the first one after the layout management unit 214 (image drawing unit) draws the display image transmitted from the user's PC 130a or 130b on the image capture layer.

Example of Processing by the Alert Controller

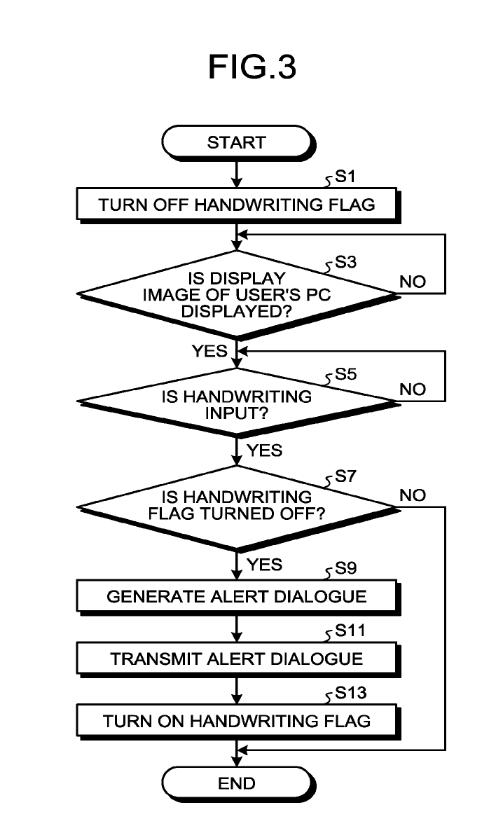

FIG. 3 is a flowchart illustrating an example of processing performed by the alert controller.

This flowchart illustrates an example of processing performed by the alert controller 223 after the image processing apparatus 110 is powered on and the user's PCs 130a and 130b are connected to the image processing apparatus 110 via the cables 124 and 126.

At Step S1, the alert controller 223 turns off a handwriting flag. In the present embodiment, the handwriting flag indicates whether the user has written something with the drawing device 240 after the image processing apparatus 110 was powered on, in other words, whether the handwriting has been detected. The handwriting flag is stored in a certain work area in the RAM. No handwriting flag indicates that no handwriting has been made after the image processing apparatus 110 was powered on, whereas an activated handwriting flag indicates that handwriting has been made after the image processing apparatus 110 was powered on.

At Step S3, the alert controller 223 determines whether the display unit 112 of the image processing apparatus 110 displays the display image of a user's PC 130. In other words, the alert controller 223 determines whether the layout management unit 214 has drawn the display image of the user's PC 130a or 130b on the image capture layer. If the display image is displayed (Yes at Step S3), the alert controller 223 performs processing at Step S5.

At Step S5, the alert controller 223 monitors whether the user has written something on the display unit 112. The alert controller 223 determines that the user has written something based on receiving the drawing instruction event issued by the event processor 210. If the alert controller 223 receives the drawing instruction event, that is, if the user has written something (Yes at Step S5), the alert controller 223 performs processing at Step S7.

At Step S7, the alert controller 223 determines whether the handwriting flag is off (0). If the handwriting flag is on (1) (No at Step S7), which means that the handwriting this time is not the first one after the image processing apparatus 110 is powered on, the alert controller 223 ends the processing. If the handwriting flag is off (Yes at Step S7), which means that the handwriting this time is the first one after the image processing apparatus 110 is powered on, the alert controller 223 performs processing at Step S9.

At Step S9, the alert controller 223 generates an alert dialogue configured to be displayed on the display unit 112. The alert dialogue contains a message that prompts the user to save the snapshot image that is a combined image of the display image of the user's PC 130 and the drawing image (handwriting image) generated by the drawing generation unit 216.

At Step S11, the alert controller 223 transmits the generated alert dialogue to the display controller 220. The display controller 220 receives the alert dialogue from the alert controller 223, and performs processing for displaying the alert dialogue on the display unit 112.

At Step S13, the alert controller 223 turns on the handwriting flag, and ends the processing.

As described above, the image processing apparatus according to the present embodiment can display, on the display unit, an alert dialogue that prompts the user to save the snapshot image when the user writes something over the display image of the user's PC for the first time after the image processing apparatus is powered on. This configuration enables the user to record the image data at appropriate timing.

The alert controller 223 in the present embodiment may use occurrence time or reception time of the events relating to handwriting instead of using the handwriting flag to generate the alert dialogue. In this case, the image processing apparatus 110 stores in advance a handwriting state management table that stores occurrence time or reception time of the events in a certain work area in the RAM.

When the alert controller 223 uses reception time of the drawing instruction event of a handwriting image instead of using the handwriting flag, the following steps differ from those in the flowchart illustrated in FIG. 3.

At Step S1, the alert controller 223 initializes the handwriting state management table.

At Step S7, the alert controller 223 determines whether the reception time of the drawing instruction event is registered in the handwriting state management table. If it is registered, the alert controller 223 ends the processing. If it is not registered, the alert controller 223 performs processing at Step S9.

At Step S13, the alert controller 223 registers the reception time of the drawing instruction event in the handwriting state management table, and ends the processing.

The alert controller 223 can display the alert dialogue at appropriate timing when performing the above processing.

Another Example of the Processing by the Alert Controller

Described next is display processing for displaying an alert dialogue according to another embodiment. In the present embodiment, the alert controller generates an alert dialogue after determining connection of the user's PC. Specifically, when an image signal of a display image transmitted from the user's PC is interrupted, the alert controller generates the alert dialogue upon determining that the image drawing unit draws an image for the first time and the handwriting detector detects handwriting for the first time after the image signal is restored.

This configuration enables the image processing apparatus 110 to display an alert dialogue when the user's PC connected to the image processing apparatus 110 is changed to another user's PC with the image processing apparatus 110 being in a powered-on state, and when the user writes something over the display image of the newly connected user's PC for the first time after the changing of the user's PCs.

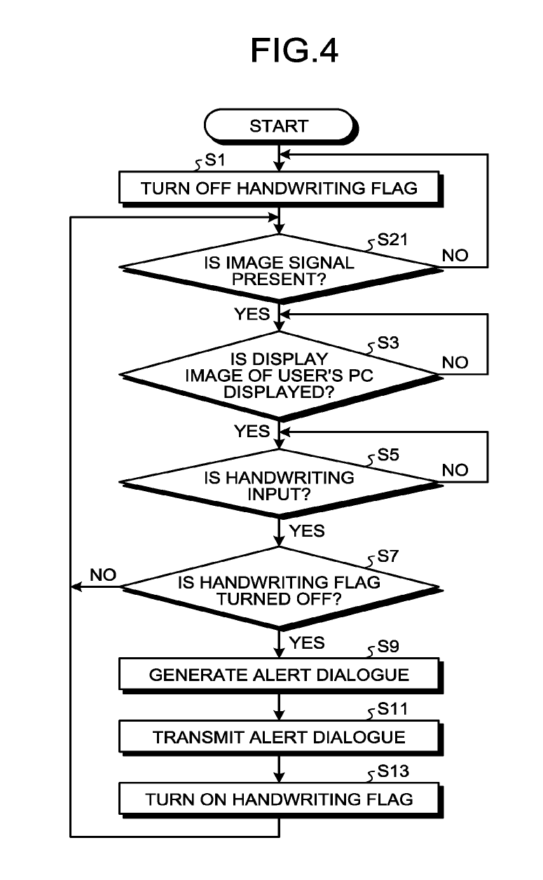

FIG. 4 is a flowchart illustrating another example of the processing performed by the alert controller. The alert controller 223 performs the processing illustrated in this flowchart when the image processing apparatus 110 is powered on and the user's PCs 130a and 130b are connected to the image processing apparatus 110 via the cables 124 and 126. The same step numbers are given to the same steps as those in the flowchart illustrated in FIG. 3, and the explanation thereof is omitted.

At Step S1, the alert controller 223 turns off the handwriting flag. The handwriting flag in the present embodiment indicates whether the user has written something with the drawing device 240 after the user's PC was connected.

At Step S21, the alert controller 223 determines whether the layout management unit 214 draws the display image of the user's PCs 130a and 130b at appropriate frequency on a display window. In other words, the alert controller 223 determines whether the layout management unit 214 keeps updating the display image of the user's PC 130 at the same frequency as the update frequency of the image frames transmitted from the user's PC 130. At Step S21, the alert controller 223 indirectly determines whether the image signal from the user's PC 130 is present. The alert controller 223 acquires information on the update frequency of the image frames from the image information received via the layout management unit 214. If the display image is drawn at appropriate frequency, in other words, if the image signal from the user's PC 130 is present (YES at Step S21), the alert controller 223 performs processing at Step S3. If the display image is not drawn at appropriate frequency, in other words, if the image signal from the user's PCs is absent (NO at Step S21), the alert controller 223 performs processing at Step S1, at which the alert controller 223 turns off the handwriting flag.

The alert controller 223 performs processing from Step S3 to Step S13. After performing the processing at Step S13, the alert controller 223 performs the processing at Step S21 again and continues the following processing.

As described above, the alert controller according to the present embodiment generates an alert dialogue by determining whether the layout management unit updates the display image of the user's PC at appropriate frequency. The alert controller can generate an alert dialogue that prompts the user to save the snapshot image when, for example, the user′ PC is disconnected for some reasons such as communication malfunction, or when the user's PC is removed and a new user's PC is connected. Thus, the image processing apparatus according to the present embodiment can record the snapshot image at appropriate timing.

The alert controller 223 according to the present embodiment may use occurrence time or reception time of the events relating to handwriting instead of using the handwriting flag to generate the alert dialogue.

The alert controller 223 may acquire, from the image acquisition unit 206, information on the image signal from the user's PC 130 regarding whether the image signal is present.

Summary of Effects of the Invention

First Aspect

The image processing apparatus 110 according to a first aspect includes an image drawing unit (layout management unit 214) that draws an image (display image of the user's PC 130) transmitted from an external device (user's PC 130), a handwriting detector (event processor 210) that detects handwriting on a display screen (display unit 112), and an alert controller (alert controller 223) that generates an alert dialogue configured to be displayed on the display screen. The alert controller generates an alert dialogue containing a certain message when the image is drawn and the handwriting is detected.

According to the first aspect, the alert controller generates the alert dialogue at timing at which the image needs to be saved. This configuration enables the user to check the alert dialogue and to record image data at appropriate timing.

Second Aspect

The image processing apparatus 110 according to a second aspect includes a handwriting image drawing unit (drawing generation unit 216) that draws the handwriting on a handwriting layer. The alert controller (alert controller 223) generates an alert dialogue containing a message that prompts the user to save a combined image of an image drawn on an image capture layer and a handwriting image drawn on the handwriting layer.

According to the second aspect, the user can check the alert dialogue containing a message that prompts the user to save the combined image, and record the image data of the combined image at appropriate timing.

Third Aspect

The alert controller (alert controller 223) of the image processing apparatus 110 according to a third aspect generates the alert dialogue when the handwriting is detected for the first time after the image processing apparatus 110 is powered on.

The alert controller generates the alert dialogue when the handwriting is input for the first time, and the user can check the alert dialogue and save image data. If the image transmitted from the external device is changed later, image data of a combined image of the image before the change and the handwriting image has successfully been saved.

Fourth Aspect

When the image signal of an image transmitted from the external device (user's PC 130) is interrupted, the alert controller (alert controller 223) of the image processing apparatus 110 according to a fourth aspect generates the alert dialogue upon determining that the image is drawn and the handwriting is detected for the first time after the image signal is restored.

The alert controller generates the alert dialogue when the user writes something for the first time after the image signal is restored, and the user can check the alert dialogue and save image data. If the image transmitted from the external device is changed later, image data of a combined image of the image before the change and the handwriting image has successfully been saved.

Fifth Aspect

An image processing method according to a fifth aspect includes a drawing step at which an image drawing unit (layout management unit 214) draws an image transmitted from an external device (user's PC 130), a detecting step at which a handwriting detector (event processor 210) detects handwriting on a display screen (display unit 112), and a generating step at which an alert controller (alert controller 223) generates an alert dialogue configured to be displayed on the display screen. The alert controller generates the alert dialogue containing a certain message when the image is drawn and the handwriting is detected.

The fifth aspect has the same effect as that in the first aspect.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

What is claimed is:

1. An image processing apparatus comprising:
an image drawing unit configured to draw an image transmitted from an external device;
a display unit configured to display thereon the image;
a handwriting image drawing unit configured to draw a handwriting image on the display unit;
a handwriting detector configured to detect handwriting image on the display unit; and
an alert controller configured to generate an alert dialogue configured to be displayed on the display unit, wherein
the alert controller includes,
a first determining unit configured to determine whether the image is displayed on the display unit, and
a second determining unit configured to determine whether the handwriting image is drawn on the display unit,
the alert controller generates, when the image is displayed and the handwriting image is drawn, an alert dialogue containing a message that prompts a user to save a combined image of the image displayed on the display unit and the handwriting image drawn on the display unit.

2. The image processing apparatus according to claim 1, wherein the alert controller generates the alert dialogue when the handwriting image is detected for a first time after the image processing apparatus is powered on.

3. The image processing apparatus according to claim 1, wherein, when an image signal of the image transmitted from the external device is interrupted, the alert controller generates the alert dialogue upon determining that the image is drawn and the handwriting image is detected for a first time after the image signal is restored.

4. The image processing apparatus according to claim 2, wherein, when an image signal of the image transmitted from the external device is interrupted, the alert controller generates the alert dialogue upon determining that the image is drawn and the handwriting image is detected for a first time after the image signal is restored.

5. An image processing method comprising:
a first drawing step at which an image drawing unit draws an image transmitted from an external device;
a displaying step at which a display unit displays thereon the image;
a second drawing step at which a handwriting image drawing unit draws a handwriting image on the display unit;
a detecting step at which a handwriting detector detects the handwriting image on the display unit; and
a generating step at which an alert controller generates an alert dialogue configured to be displayed on the display unit, wherein
the second drawing step includes,
a first determining step at which a first determining unit determines whether the image is displayed on the display unit, and
a second determining step at which a second determining unit determines whether the handwriting image is drawn on the display unit,
the alert controller generates, when the image is displayed and the handwriting image is drawn, an alert dialogue containing a message that prompts a user to save a combined image of the image displayed on the display unit and the handwriting image drawn on the display unit.
